(19) United States
(12) Patent Application Publication
(10) Pub. No.: US 2021/0167393 A1
(43) Pub. Date: Jun. 3, 2021

(54) LITHIUM ION SECONDARY BATTERY

(71) Applicant: HITACHI CHEMICAL COMPANY, LTD., Tokyo (JP)

(72) Inventors: Hiroki KUZUOKA, Chiyoda-ku, Tokyo (JP); Eisuke HABA, Chiyoda-ku, Tokyo (JP); Shunsuke NAGAI, Chiyoda-ku, Tokyo (JP); Takuya NISHIMURA, Chiyoda-ku, Tokyo (JP); Kenji TAKAOKA, Chiyoda-ku, Tokyo (JP)

(21) Appl. No.: 16/071,129

(22) PCT Filed: Jan. 17, 2017
(86) PCT No.: PCT/JP2017/001439

§ 371 Date: Jul. 19, 2018

(30) Foreign Application Priority Data
Jan. 20, 2016 (JP) 2016-008470
Jan. 20, 2016 (JP) 2016-008471

(51) Int. Cl. H01M 4/62; H01M 10/0525; H01M 50/446

(52) U.S. Cl. CPC H01M 4/628; H01M 10/0525; H01M 2004/028; H01M 4/622; H01M 50/446

(57) ABSTRACT

Provided is a lithium ion secondary battery including: a positive electrode; a negative electrode; a separator; and an electrolyte, wherein: the positive electrode includes a current collector and a positive electrode active material layer formed on the current collector, the positive electrode active material layer contains a positive electrode active material, polyolefin particles, conductive particles and a binder, and the separator has a thermal shrinkage rate of 30% or less at 160° C.

### TECHNICAL FIELD

The present invention relates to a lithium ion secondary battery.

### BACKGROUND ART

Lithium ion secondary batteries, which are energy devices having a high energy density, have been widely used as power sources of portable information terminals, such as laptop computers, cellular phones, and PDAs (Personal Digital Assistants).

In a representative lithium ion secondary battery, an electrode assembly is constituted by alternately layering a positive electrode and a negative electrode via a separator. As an active material of the negative electrode, a carbon material having a multilayer structure that is capable of intercalating and releasing lithium ions between layers is mainly used. As an active material of the positive electrode, a lithium-containing composite metal oxide is mainly used. Further, as the separator, a polyolefin porous film is mainly used. Lithium ion secondary batteries constituted by such materials have high battery capacity (discharge capacity) and output and exhibit favorable charge-discharge cycle characteristics.

Lithium ion secondary batteries are also at a high level in terms of safety. However, in lithium ion secondary batteries, a further improvement in safety is still demanded because of their high capacity and high output. For instance, when a lithium ion secondary battery is overcharged, heat may be generated and thermal runaway may occur. Accordingly, the method of Patent Document 1 has been proposed as a method of inhibiting heat generation by cutting off an electric current. In Patent Document 1, it is disclosed that, by arranging a PTC (Positive Temperature Coefficient) layer, which contains conductive particles, polyolefin particles and a water-soluble polymer, on a positive electrode current collector, the internal resistance of a lithium ion secondary battery is increased and an electric current is thus made unlikely to flow when the temperature of the lithium ion secondary battery is increased, as a result of which an effect of inhibiting overheating of the lithium ion secondary battery is exerted.

### RELATED ART DOCUMENT

### Patent Document

[Patent Document 1] International Publication Number WO 2015/046469

### SUMMARY OF INVENTION

### Technical Problem

However, the lithium ion secondary battery described in Patent Document 1 has a problem in that the formation of the PTC layer between the current collector and the active material layer makes the production process complex.

The invention was made in view of the above-described circumstances, and an object of the invention is to provide a lithium ion secondary battery which has a function of increasing the internal resistance of the battery (hereinafter, may be also referred to as “direct-current resistance”) when the temperature is increased and exhibits excellent battery characteristics and safety during normal operation, and whose production steps are simple.

### Solution to Problem

Concrete means for achieving the above-described object are as follows.

<1> A lithium ion secondary battery, comprising:

a positive electrode;

a negative electrode;

a separator; and

an electrolyte, wherein:

the positive electrode comprises a current collector and a positive electrode active material layer formed on the current collector,

the positive electrode active material layer comprises a positive electrode active material, polyolefin particles, conductive particles and a binder, and

the separator has a thermal shrinkage rate of 30% or less at 160° C.

<2> The lithium ion secondary battery according to <1>, wherein:

the separator comprises a porous substrate and inorganic particles, and

the porous substrate comprises two or more different kinds of resin selected from the group consisting of a polypropylene resin, a polyethylene resin, a polyvinyl alcohol resin, a polyethylene terephthalate resin, a polyacrylonitrile resin, and an aramid resin.

<3> The lithium ion secondary battery according to <2>, wherein the porous substrate comprises a polyethylene resin and a polypropylene resin.

<4> The lithium ion secondary battery according to any one of <1> to <3>, wherein the separator has a thermal shrinkage rate of 20% or less at 160° C.

<5> The lithium ion secondary battery according to any one of <1> to <4>, wherein the separator has a Gurley value of 1,000 sec/100 cc or less.

<6> The lithium ion secondary battery according to <1>, wherein: the separator comprises a porous substrate and inorganic particles, and

the porous substrate comprises a polyester resin.

<7> The lithium ion secondary battery according to <6>, wherein the polyester resin comprises a polyethylene terephthalate resin.

<8> A lithium ion secondary battery, comprising:

a positive electrode;

a negative electrode;

a separator; and

an electrolyte, wherein:

the positive electrode comprises a current collector and a positive electrode active material layer formed on the current collector,

the positive electrode active material layer comprises a positive electrode active material, polyolefin particles, conductive particles, and a binder,

the separator comprises a porous substrate and inorganic particles, and

the porous substrate is a layered body comprising a polypropylene resin and a polyethylene resin disposed alternately in layers.

<9> A lithium ion secondary battery, comprising:

a positive electrode;

a negative electrode;

a separator; and

an electrolyte, wherein:

the positive electrode comprises a current collector and a positive electrode active material layer formed on the current collector,

the positive electrode active material layer comprises a positive electrode active material, polyolefin particles, conductive particles and a binder, and

the separator comprises a woven or nonwoven fabric of a polyethylene terephthalate resin, and inorganic particles.

<10> The lithium ion secondary battery according to any one of <2>, <6>, <8> and <9>, wherein the inorganic particles comprise at least one of aluminum oxide (Al₂O₃) or silicon oxide (SiO₂).

<11> The lithium ion secondary battery according to any one of <1> to <10>, wherein the separator has a thickness of from 5 μm to 100 μm.

<12> The lithium ion secondary battery according to any one of <1> to <11>, wherein the binder comprises a resin including a structural unit derived from a nitrile group-containing monomer.

### Advantageous Effects of Invention

According to the invention, a lithium ion secondary battery which has a function of increasing the internal resistance of the battery when the temperature is increased and exhibits excellent battery characteristics and safety during normal operation, and whose production steps are simple, can be provided.

### BRIEF DESCRIPTION OF DRAWINGS

FIG. 1 is a cross-sectional view of a lithium ion secondary battery to which the disclosure is applied.

### DESCRIPTION OF EMBODIMENTS

Preferred embodiments of the invention are described below. It is noted here that matters required for carrying out the invention, which exclude those matters specifically mentioned in the present specification, may be construed as design matters for those of ordinary skill in the art based on the prior art in the pertinent field. The invention can be carried out based on the matters disclosed in the present specification and the common technical knowledge in the pertinent field. Further, the dimensional relationships (e.g., length, width, and thickness) in the drawing provided below do not necessarily reflect the actual dimensional relationships.

In the present specification, those numerical ranges that are expressed with “to” each denote a range that includes the numerical values stated before and after “to” as the minimum value and the maximum value, respectively. In a set of numerical ranges that are stated stepwisely in the present specification, the upper limit value or the lower limit value of a numerical range may be replaced with the upper limit value or the lower limit value of another numerical range. Further, in a numerical range stated in the present specification, the upper limit or the lower limit of the numerical range may be replaced with a relevant value indicated in any of Examples.

In the present specification, when there are plural kinds of substances that correspond to a component of a composition, the content ratio or content of the component in the composition means, unless otherwise specified, the total content ratio or content of the plural kinds of substances existing in the composition.

In the present specification, when there are plural kinds of particles that correspond to a component of a composition, the particle size of the component in the composition means, unless otherwise specified, a value determined for a mixture of the plural kinds of particles existing in the composition.

In the present specification, the term “layer” encompasses not only those configurations formed over the entirety of a surface but also those configurations partially formed on a surface when the layer is observed in a plane view.

In the present specification, the term “dispose in layers” indicates that layers are stacked on top of each other, and the two or more layers may be bonded with each other or may be detachable from one another.

In the present specification, “(meth)acrylate” means acrylate or methacrylate; “(meth)acrylonitrile” means acrylonitrile or methacrylonitrile; “(meth)acrylic acid” means acrylic acid or methacrylic acid; “(meth)acrylamide” means acrylamide or methacrylamide; and “(meth)allyl” means allyl or methallyl.

The technology of the disclosure can be widely applied to a variety of non-aqueous secondary batteries that include electrodes in the form of having active material layers (a positive electrode active material layer and a negative electrode active material layer) formed on a current collector. The details thereof are described below.

A first lithium ion secondary battery of the disclosure is a lithium ion secondary battery which includes: a positive electrode; a negative electrode; a separator; and an electrolyte, wherein the positive electrode includes a current collector and a positive electrode active material layer formed on the current collector, the positive electrode active material layer contains a positive electrode active material, polyolefin particles, conductive particles and a binder, and the separator has a thermal shrinkage rate of 30% or less at 160° C.

Further, a second lithium ion secondary battery of the disclosure is a lithium ion secondary battery which includes: a positive electrode; a negative electrode; a separator; and an electrolyte, wherein the positive electrode includes a current collector and a positive electrode active material layer formed on the current collector, the positive electrode active material layer contains a positive electrode active material, polyolefin particles, conductive particles and a binder, the separator includes a porous substrate and inorganic particles, and the porous substrate is a layered body including a polypropylene resin and a polyethylene resin disposed alternately in layers.

Still further, a third lithium ion secondary battery of the disclosure is a lithium ion secondary battery which includes: a positive electrode; a negative electrode; a separator; and an electrolyte, wherein the positive electrode includes a current collector and a positive electrode active material layer formed on the current collector, the positive electrode active material layer contains a positive electrode active material, polyolefin particles, conductive particles and a binder, and the separator includes a woven or nonwoven fabric of a polyethylene terephthalate resin, and inorganic particles.

The first lithium ion secondary battery, the second lithium ion secondary battery and the third lithium ion secondary battery may be hereinafter collectively referred to as “the lithium ion secondary battery of the disclosure”.

(Positive Electrode)

The positive electrode for the lithium ion secondary battery of the disclosure includes a current collector (positive electrode current collector) and a positive electrode active material layer, and this positive electrode active material layer contains a positive electrode active material, conductive particles, polyolefin particles, and a binder.

<Positive Electrode Active Material Layer>

The positive electrode active material layer, which contains a positive electrode active material, conductive particles, polyolefin particles and a binder, is formed on the positive electrode current collector. More specifically, the positive electrode active material layer is formed on one or both surfaces in the thickness direction of the positive electrode current collector.

The formation method thereof is not restricted and, for example, the positive electrode active material layer is formed as follows. For example, a method in which the positive electrode active material, the polyolefin particles, the conductive particles and the binder as well as other materials that are used as required are mixed by a dry process without using any dispersion solvent and then molded into a sheet form, and the thus obtained sheet is press-bonded to the positive electrode current collector (dry method), may be employed. Alternatively, a method in which the positive electrode active material, the polyolefin particles, the conductive particles and the binder as well as other materials that are used as required are dissolved or dispersed in a dispersion solvent to prepare a positive electrode mixture paste, and this paste is subsequently coated and dried on the positive electrode current collector (wet method), may be employed.

As the positive electrode current collector, any positive electrode current collector that is commonly used in this field can be used, and examples thereof include sheets and foils that contain stainless steel, aluminum, titanium or the like.

Thereamong, the positive electrode current collector is preferably an aluminum sheet or foil. The thickness of the sheet or foil is not particularly restricted; however, from the standpoint of ensuring the strength and the processability that are required as a current collector, the thickness of the sheet or foil is, for example, preferably from 1 μm to 500 μm, more preferably from 1.5 μm to 200 μm, still more preferably from 2 μm to 80 μm, particularly preferably from 5 μm to 50 μm.

As the positive electrode active material, any positive electrode active material that is commonly used in this field can be used, and examples thereof include lithium-containing metal oxides, olivine-type lithium salts, chalcogen compounds, and manganese dioxide. The lithium-containing metal oxides are metal oxides containing lithium and a transition metal, or metal oxides in which a transition metal in the metal oxides containing lithium and a transition metal is partially substituted with a different element. Examples of the different element include Na, Mg, Sc, Y, Mn, Fe, Co, Ni, Cu, Zn, Al, Cr, Pb, Sb and B, among which Mn, Al, Co, Ni and Mg are preferred. These different elements may be used singly, or in combination of two or more kinds thereof.

Among such substances, a lithium-containing composite metal oxide is preferred as the positive electrode active material. Examples of the lithium-containing composite metal oxide include LiₓCoO₂, LiₓNiO₂, LiₓMnO₂, LiₓCo_{y}Ni_{1-y}O₂, LiₓCo_{y}M¹_{1-y}O_{z} (wherein, M¹ represents at least one element selected from the group consisting of Na, Mg, Sc, Y, Mn, Fe, Ni, Cu, Zn, Al, Cr, Pb, Sb, V, and B), LiₓNi_{1-y}M²_{y}O_{z} (wherein, M² represents at least one element selected from the group consisting of Na, Mg, Sc, Y, Mn, Fe, Co, Cu, Zn, Al, Cr, Pb, Sb, V, and B), LiₓMn₂O₄, and LiₓMn_{2-y}M³_{y}O₄ (wherein, M³ represents at least one element selected from the group consisting of Na, Mg, Sc, Y, Fe, Co, Ni, Cu, Zn, Al, Cr, Pb, Sb, V, and B). In these formulae, x is 0<x≤1.2, y is from 0 to 0.9, and z is from 2.0 to 2.3. The value of x representing the molar ratio of lithium is increased or decreased by charging and discharging. Examples of the olivine-type lithium salts include LiFePO₄. Further, examples of the chalcogen compounds include titanium disulfide and molybdenum disulfide. These positive electrode active materials may be used singly, or in combination of two or more kinds thereof.

From the safety standpoint, the positive electrode active material contains preferably a lithium manganese oxide expressed by LiₓMn₂O₄ or LiₓMn_{2-y}M³_{y}O₄, more preferably a lithium-nickel-manganese-cobalt composite oxide. When a lithium manganese oxide is used in the positive electrode active material, the content ratio of the lithium manganese oxide is preferably not less than 30% by mass, more preferably not less than 40% by mass, with respect to the total amount of the positive electrode active material.

The polyolefin particles used in the positive electrode active material layer are not particularly restricted as long as they are non-conductive particles of a thermoplastic resin. Examples of a material of such polyolefin particles include polyethylene, polypropylene, polymethylpentene, and polybutene. In the disclosure, resin particles other than the polyolefin particles may also be used in combination. Examples of a material of such resin particles include ethylene-vinyl acetate copolymers (EVA), polyvinyl chlorides, polyvinylidene chlorides, polyvinyl fluorides, polyvinylidene fluorides, polyamides, polystyrenes, polyacrylonitriles, thermoplastic elastomers, polyethylene oxides, polyacetals, thermoplastic modified cellulose, polysulfones, and polymethyl (meth)acrylates. Thereamong, polyolefin particles of polyethylene, polypropylene or the like are preferred since excellent swelling resistance against electrolyte solutions and excellent electrochemical stability are attained. These polyolefin particles may be used singly, or in combination of two or more kinds thereof.

The mass-based ratio of the polyolefin particles with respect to the total amount of the polyolefin particles and other resin particles is preferably from 70% by mass to 100% by mass, more preferably from 80% by mass to 100% by mass.

The average particle size of the polyolefin particles is, from the standpoint of easily dispersing the particles and uniformly forming the positive electrode active material layer on the current collector, preferably from 0.1 μm to 30 μm, more preferably from 0.5 μm to 15 μm, still more preferably from 2.5 μm to 10 μm. The larger the average particle size of the polyolefin particles, the more easily the polyolefin particles are dispersed and, the smaller the average particle size of the polyolefin particles, the more uniformly the positive electrode active material layer tends to be formed on the current collector. Further, the larger the average particle size of the polyolefin particles, the further the battery properties tend to be improved. The average particle size of the polyolefin particles can be, for example, a value obtained by taking an arithmetic mean of long axis length values measured for all of the polyolefin particles included in a transmission electron micrograph of a 50 μm (in length)×50 μm (width) area that was taken for a central part of a current collector on which a positive electrode active material layer containing the polyolefin particles is formed at a thickness of about 70 μm.

Because of the presence of the polyolefin particles in the positive electrode active material layer, the resistance of the positive electrode active material layer is increased when the temperature of the positive electrode active material layer is increased to a prescribed temperature or higher due to heat generation of the lithium ion secondary battery, so that a function of reducing the current flowing in the positive electrode active material layer (hereinafter, may also be referred to as “PTC function”) can be imparted.

The temperature at which the PTC function is expressed can be controlled based on the melting point (Tm) of the polyolefin particles. In other words, when the temperature of the positive electrode active material layer reaches the vicinity of the melting point of the polyolefin particles, the polyolefin particles are swollen or melted, as a result of which conductive paths in the positive electrode active material layer are cut and the PTC function is thereby expressed. The melting point (Tm) of the polyolefin particles is not particularly restricted; however, from the standpoints of the ease of handling, safety, service temperature range and productivity of the lithium ion secondary battery, the melting point (Tm) of the polyolefin particles is preferably from 70° C. to 160° C., more preferably from 70° C. to 140° C., still more preferably from 80° C. to 150° C., particularly preferably from 90° C. to 120° C.

A lower melting point (Tm) of the polyolefin particles allows the PTC function to be expressed at a lower temperature, so that the safety can be improved. Meanwhile, a higher melting point (Tm) of the polyolefin particles can better inhibit malfunction during normal use and allows the positive electrode drying temperature to be set higher, so that the productivity can be improved. The melting point (Tm) of the polyolefin particles can be calculated, for example, from an endothermic peak temperature after measuring the specific heat capacity of the polyolefin particles in an inert gas as a function of temperature using a differential scanning calorimeter.

When polyolefin particles are used in the positive electrode active material layer, from the standpoint of satisfying both battery properties and PTC function, the content ratio of the polyolefin particles is preferably from 0.1% by mass to 10% by mass, more preferably from 0.5% by mass to 8% by mass, still more preferably from 2.5% by mass to 6.5% by mass, with respect to the total amount of the positive electrode active material layer. A higher ratio of the polyolefin particles tends to provide the positive electrode active material layer with superior PTC function, while a lower ratio of the polyolefin particles tends to provide the positive electrode active material layer with superior battery properties.

The form of the polyolefin particles added to a sheet or a paste is not particularly restricted as long as the particle form of polyolefin is maintained, and the polyolefin particles can be added, for example, in the form of powder that has been dried or in the form of being dispersed in a solvent. From the standpoint of preventing moisture from being mixed into the positive electrode mixture paste, the powder is preferably used after being dried and, from the standpoint of favorably dispersing the polyolefin particles in the positive electrode mixture paste, it is preferred to use the polyolefin particles in the form of being dispersed in a solvent. The solvent in which the polyolefin particles are dispersed is not particularly restricted, and examples thereof include N-methyl-2-pyrrolidone (NMP), tetrahydrofuran, and dimethylformamide.

As the conductive particles used in the positive electrode active material layer, any conductive particles that are commonly used in this field can be used, and examples thereof include carbon blacks, graphites, carbon fibers, and metal fibers. Examples of the carbon blacks include acetylene black, Ketjen black, channel black, furnace black, lamp black, and thermal black. Examples of the graphites include natural graphites and artificial graphites. These conductive particles may be used singly, or in combination of two or more kinds thereof.

When conductive particles are used in the positive electrode active material layer, from the standpoint of satisfying both battery properties and PTC function, the content of the conductive particles is, in terms of mass ratio between the polyolefin particles and the conductive particles that are contained in the positive electrode active material layer (polyolefin particles/conductive particles), preferably from 0.15/0.85 to 0.85/0.15, more preferably from 0.3/0.7 to 0.7/0.3, still more preferably from 0.4/0.6 to 0.6/0.4. A higher ratio of the conductive particles tends to provide the positive electrode active material layer with superior battery properties, while a lower ratio of the conductive particles tends to provide the positive electrode active material layer with superior PTC function.

As the binder used in the positive electrode active material layer, any binder that is commonly used in this field can be used, and examples thereof include resins including a structural unit derived from a nitrile group-containing monomer, polyvinyl acetates, polymethyl methacrylates, nitrocellulose, fluorocarbon resins, and rubbers. Examples of the fluorocarbon resins include polytetrafluoroethylenes (PTFE), polyvinylidene fluorides (PVDF), tetrafluoroethylene-hexafluoropropylene copolymers (FEP), and vinylidene fluoride-hexafluoropropylene copolymer. Examples of the rubbers include styrene-butadiene rubbers and acrylonitrile rubbers. Thereamong, from the standpoints of the swelling resistance against electrolyte solutions and the bindability, it is particularly preferred to use a resin including a structural unit derived from a nitrile group-containing monomer.

(Resin Containing Structural Unit Derived from Nitrile Group-Containing Monomer)

The resin including a structural unit derived from a nitrile group-containing monomer is preferably soluble or readily soluble in an organic solvent. Such a binder may be used singly, or in combination of two or more kinds thereof as required.

Examples of the resin including a structural unit derived from a nitrile group-containing monomer include copolymers of (meth)acrylonitrile with other compound having an ethylenically unsaturated bond. From the standpoint of further improving the elasticity and the bindability, it is preferred that the resin including a structural unit derived from a nitrile group-containing monomer contains a structural unit derived from a nitrile group-containing monomer, and at least one structural unit selected from the group consisting of a structural unit derived from a monomer represented by the following Formula (I) and a structural unit derived from a monomer represented by the following Formula (II). From the standpoint of further improving the bindability, it is also preferred that the resin including a structural unit derived from a nitrile group-containing monomer contains a carboxy group-containing structural unit derived from a carboxy group-containing monomer.

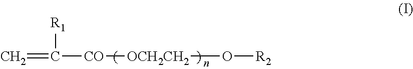

(wherein, R₁ represents a hydrogen atom or a methyl group; R₂ represents a hydrogen atom or a monovalent hydrocarbon group; and n represents an integer of 1 to 50)

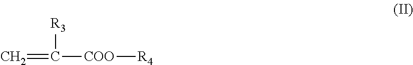

(wherein, R₃ represents a hydrogen atom or a methyl group; and R₄ represents an alkyl group having from 4 to 100 carbon atoms)

<Nitrile Group-Containing Monomer>

The nitrile group-containing monomer is not particularly restricted, and examples thereof include acrylic nitrile group-containing monomers, such as acrylonitrile and methacrylonitrile; cyanic nitrile group-containing monomers, such as α-cyanoacrylate and dicyanovinylidene; and fumaric nitrile group-containing monomers, such as fumaronitrile. Thereamong, acrylonitrile is preferred from the standpoints of the flexibility and elasticity of the electrodes. These nitrile group-containing monomers may be used singly, or in combination of two or more kinds thereof.

When at least one of acrylonitrile and methacrylonitrile is used as a nitrile group-containing monomer, the total content ratio of a structural unit derived from acrylonitrile and a structural unit derived from methacrylonitrile is preferably from 40% by mass to 98% by mass, more preferably from 50% by mass to 96% by mass, still more preferably from 60% by mass to 95% by mass, with respect to the total amount of the resin including a structural unit derived from a nitrile group-containing monomer, which is a binder.

<Monomer Represented by Formula (I)>

The monomer represented by Formula (I) is not particularly restricted. In Formula (I), R₁ is a hydrogen atom or a methyl group, and n is an integer of 1 to 50, preferably an integer of 2 to 30, more preferably an integer of 2 to 10. R₂ is a hydrogen atom or a monovalent hydrocarbon group which is, for example, preferably a hydrocarbon group having from 1 to 50 carbon atoms, more preferably a hydrocarbon group having from 1 to 25 carbon atoms, still more preferably a hydrocarbon group having from 1 to 12 carbon atoms. When the hydrocarbon group has 50 or less carbon atoms, sufficient swelling resistance against electrolyte solutions tends to be obtained.

The hydrocarbon group is preferably, for example, an alkyl group or a phenyl group. R₂ is particularly preferably an alkyl group having from 1 to 12 carbon atoms, or a phenyl group. This alkyl group may be linear or branched.

When R₂ is an alkyl group or a phenyl group, a hydrogen atom(s) of the alkyl group or phenyl group may be substituted with a halogen atom (e.g., a fluorine atom, a chlorine atom, a bromine atom, or an iodine atom), a nitrogen atom-containing group, a phosphorus atom-containing group, an aromatic group, a cycloalkyl group having from 3 to 10 carbon atoms, or the like.

Examples of commercially available monomers represented by Formula (I) include ethoxy diethylene glycol acrylate (trade name: LIGHT ACRYLATE EC-A, manufactured by Kyoeisha Chemical Co., Ltd.), methoxy triethylene glycol acrylate (trade name: LIGHT ACRYLATE MTG-A, manufactured by Kyoeisha Chemical Co., Ltd.; and trade name: NK ESTER AM-30G manufactured by Shin-Nakamura Chemical Co., Ltd.), methoxy poly(n=9)ethylene glycol acrylate (trade name: LIGHT ACRYLATE 130-A, manufactured by Kyoeisha Chemical Co., Ltd.; and trade name: NK ESTER AM-90G manufactured by Shin-Nakamura Chemical Co., Ltd.), methoxy poly(n=13)ethylene glycol acrylate (trade name: NK ESTER AM-130G; manufactured by Shin-Nakamura Chemical Co., Ltd.), methoxy poly(n=23)ethylene glycol acrylate (trade name: NK ESTER AM-230G, manufactured by Shin-Nakamura Chemical Co., Ltd.), octoxy poly(n=18)ethylene glycol acrylate (trade name: NK ESTER A-OC-18E, manufactured by Shin-Nakamura Chemical Co., Ltd.), phenoxydiethylene glycol acrylate (trade name: LIGHT ACRYLATE P-200A, manufactured by Kyoeisha Chemical Co., Ltd.; and trade name: NK ESTER AMP-20GY, manufactured by Shin-Nakamura Chemical Co., Ltd.), phenoxy poly(n=6)ethylene glycol acrylate (trade name: NK ESTER AMP-60G, manufactured by Shin-Nakamura Chemical Co., Ltd.), nonylphenol EO adduct (n=4) acrylate (trade name: LIGHT ACRYLATE NP-4EA, manufactured by Kyoeisha Chemical Co., Ltd.), nonylphenol EO adduct (n=8) acrylate (trade name: LIGHT ACRYLATE NP-8EA, manufactured by Kyoeisha Chemical Co., Ltd.), methoxy diethylene glycol methacrylate (trade name: LIGHT ESTER MC, manufactured by Kyoeisha Chemical Co., Ltd.; and trade name: NK ESTER M-20G, manufactured by Shin-Nakamura Chemical Co., Ltd.), methoxy triethylene glycol methacrylate (trade name: LIGHT ESTER MTG, manufactured by Kyoeisha Chemical Co., Ltd.), methoxy poly(n=9)ethylene glycol methacrylate (trade name: LIGHT ESTER 130MA, manufactured by Kyoeisha Chemical Co., Ltd.; and trade name: NK ESTER M-90G, manufactured by Shin-Nakamura Chemical Co., Ltd.), methoxy poly(n=23)ethylene glycol methacrylate (trade name: NK ESTER M-230G, manufactured by Shin-Nakamura Chemical Co., Ltd.), and methoxy poly(n=30)ethylene glycol methacrylate (trade name: LIGHT ESTER 041MA, manufactured by Kyoeisha Chemical Co., Ltd.). It is noted here that “EO” means an ethyleneoxy group and “n” means the number of structural units of the ethyleneoxy group. Among these monomers, from the standpoints of, for example, the reactivity in copolymerization with a nitrile group-containing monomer, methoxy triethylene glycol acrylate (a compound represented by Formula (I) wherein R₁ is a hydrogen atom, R₂ is a methyl group, and n is 3) is more preferred. These monomers represented by Formula (I) may be used singly, or in combination of two or more kinds thereof.

<Monomer Represented by Formula (II)>

The monomer represented by Formula (II) is not particularly restricted. In Formula (II), R₃ is a hydrogen atom or a methyl group.

R₄ is a hydrogen atom or an alkyl group having from 4 to 100 carbon atoms. R₄ is preferably an alkyl group having from 4 to 50 carbon atoms, more preferably an alkyl group having from 6 to 30 carbon atoms, still more preferably an alkyl group having from 8 to 15 carbon atoms. When the alkyl group has 4 or more carbon atoms, the electrodes tend to exhibit sufficient elasticity, whereas when the alkyl group has 100 or less carbon atoms, sufficient swelling resistance against electrolyte solutions tends to be obtained.

The alkyl group constituting R₄ may be linear, branched, or cyclic.

Further, a hydrogen atom(s) of the alkyl group constituting R₄ may be substituted with a halogen atom (e.g., a fluorine atom, a chlorine atom, a bromine atom, or an iodine atom), a nitrogen atom-containing group, a phosphorus atom-containing group, an aromatic group, a cycloalkyl group having from 3 to 10 carbon atoms, or the like. Examples of the alkyl group constituting R₄ include linear, branched or cyclic saturated alkyl groups as well as halogenated alkyl groups, such as fluoroalkyl groups, chloroalkyl groups, bromoalkyl groups, and iodoalkyl groups.

When R₄ is a linear, branched or cyclic saturated alkyl group, examples of the monomer represented by Formula (II) include (meth)acrylates containing an alkyl group having from 4 to 100 carbon atoms, such as n-butyl (meth)acrylate, isobutyl (meth)acrylate, t-butyl (meth)acrylate, amyl (meth)acrylate, isoamyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, isodecyl (meth)acrylate, lauryl (meth)acrylate, tridecyl (meth)acrylate, hexadecyl (meth)acrylate, stearyl (meth)acrylate, isostearyl (meth)acrylate, cyclohexyl (meth)acrylate, and isobornyl (meth)acrylate. Further, when R₄ is a fluoroalkyl group, examples of the monomer represented by Formula (II) include acrylate compounds, such as 1,1-bis(trifluoromethyl)-2,2,2-trifluoroethyl acrylate, 2,2,3,3,4,4,4-heptafluorobutyl acrylate, 2,2,3,4,4,4-hexafluorobutyl acrylate, nonafluoroisobutyl acrylate, 2,2,3,3,4,4,5,5-octafluoropentyl acrylate, 2,2,3,3,4,4,5,5,5-nonafluoropentyl acrylate, 2,2,3,3,4,4,5,5,6,6,6-undecafluorohexyl acrylate, 2,2,3,3,4,4,5,5,6,6,7,7,8,8,8-pentadecafluorooctyl acrylate, 3,3,4,4,5,5,6,6,7,7,8,8,9,9,10,10,10-heptadecafluorodecyl acrylate, and 2,2,3,3,4,4,5,5,6,6,7,7,8,8,9,9,10,10,10-nonadecafluorodecyl acrylate; and methacrylate compounds, such as nonafluoro-t-butyl methacrylate, 2,2,3,3,4,4,4-heptafluorobutyl methacrylate, 2,2,3,3,4,4,5,5-octafluoropentyl methacrylate, 2,2,3,3,4,4,5,5,6,6,7,7-dodecafluoroheptyl methacrylate, heptadecafluorooctyl methacrylate, 2,2,3,3,4,4,5,5,6,6,7,7,8,8,8-pentadecafluorooctyl methacrylate, and 2,2,3,3,4,4,5,5,6,6,7,7,8,8,9,9-hexadecafluorononyl methacrylate. These monomers represented by Formula (II) may be used singly, or in combination of two or more kinds thereof.

When a monomer represented by Formula (I) or a monomer represented by Formula (II) is used, the content ratio of at least one structural unit selected from the group consisting of a structural unit derived from the monomer represented by Formula (I) and a structural unit derived from the monomer represented by Formula (II) is preferably from 1% by mass to 50% by mass, more preferably from 2% by mass to 30% by mass, still more preferably from 3% by mass to 20% by mass, with respect to the total amount of the resin including a structural unit derived from a nitrile group-containing monomer, which is a binder. A higher content of the structural unit derived from the monomer represented by Formula (I) or the structural unit derived from the monomer represented by Formula (II) is likely to further improve the elasticity and the bindability, while a lower content is likely to further improve the swelling resistance against electrolyte solutions and the electrochemical stability of the positive electrode during use.

<Carboxy Group-Containing Monomer>

The carboxy group-containing monomer is not particularly restricted. Examples of the carboxy group-containing monomer include acrylic carboxy group-containing monomers, such as acrylic acid and methacrylic acid; crotonic carboxy group-containing monomers, such as crotonic acid; maleic carboxy group-containing monomers, such as maleic acid and anhydride thereof; itaconic carboxy group-containing monomers, such as itaconic acid and anhydride thereof; and citraconic carboxy group-containing monomers, such as citraconic acid and anhydride thereof. Thereamong, acrylic acid is preferred from the standpoints of the flexibility of the electrodes and bindability.

These carboxy group-containing monomers may be used singly, or in combination of two or more kinds thereof.

When a carboxy group-containing monomer is used, the content ratio of a structural unit derived from the carboxy group-containing monomer is preferably from 0.1% by mass to 20% by mass, more preferably from 1% by mass to 10% by mass, still more preferably from 2% by mass to 6% by mass, with respect to the total amount of the resin including a structural unit derived from a nitrile group-containing monomer, which is a binder. A higher content of the carboxy group-containing monomer is likely to further improve the elasticity and the bindability, while a lower content is likely to further improve the swelling resistance against electrolyte solutions and the electrochemical stability of the positive electrode during use.

<Other Monomers>

In the resin including a structural unit derived from a nitrile group-containing monomer, in addition to the structural unit derived from a nitrile group-containing monomer, the carboxy group-containing structural unit derived from a carboxy group-containing monomer and the at least one structural unit selected from the group consisting of a structural unit derived from a monomer represented by Formula (I) and a structural unit derived from a monomer represented by Formula (II), a structural unit of other monomer different from the above-described monomers may also be used in combination as appropriate. Such an other monomer is not particularly restricted, and examples thereof include short-chain (meth)acrylates, such as methyl (meth)acrylate, ethyl (meth)acrylate, and propyl (meth)acrylate; halogenated vinyl compounds, such as vinyl chloride, vinyl bromide, and vinylidene chloride; maleic acid imide; phenylmaleimide; (meth)acrylamide; styrene; a-methylstyrene; vinyl acetate; sodium (meth)allylsulfonate; sodium (meth)allyloxybenzenesulfonate; sodium styrenesulfonate; and 2-acrylamide-2-methylpropane sulfonic acid and salts thereof. These other monomers may be used singly, or in combination of two or more kinds thereof.

<Content of Structural Unit Derived From Each Monomer>

In cases where the resin including a structural unit derived from a nitrile group-containing monomer contains a structural unit derived from a nitrile group-containing monomer, a carboxy group-containing structural unit derived from a carboxy group-containing monomer and at least one structural unit selected from the group consisting of a structural unit derived from a monomer represented by Formula (I) and a structural unit derived from a monomer represented by Formula (II), as for the molar ratios of the structural unit derived from a nitrile group-containing monomer, the carboxy group-containing structural unit derived from a carboxy group-containing monomer and the at least one structural unit selected from the group consisting of a structural unit derived from a monomer represented by Formula (I) and a structural unit derived from a monomer represented by Formula (II), for example, with respect to 1 mol of the structural unit derived from a nitrile group-containing monomer, the carboxy group-containing structural unit derived from a carboxy group-containing monomer is contained at a molar ratio of preferably from 0.01 mol to 0.2 mol, more preferably from 0.02 mol to 0.1 mol, still more preferably from 0.03 mol to 0.06 mol, and the structural unit derived from a monomer represented by Formula (I) or Formula (II) is contained at a molar ratio of preferably from 0.001 mol to 0.2 mol, more preferably from 0.003 mol to 0.05 mol, still more preferably from 0.005 mol to 0.02 mol. As long as the molar ratio of the carboxy group-containing structural unit derived from a carboxy group-containing monomer is from 0.01 mol to 0.2 mol and that of the structural unit derived from a monomer represented by Formula (I) or Formula (II) is from 0.001 mol to 0.2 mol, excellent adhesion with a current collector, particularly a positive electrode current collector using an aluminum foil, as well as excellent swelling resistance against electrolyte solutions are attained, and the electrodes exhibit favorable flexibility and elasticity.

When other monomer is used, the content thereof is preferably from 0.005 mol to 0.1 mol, more preferably from 0.01 mol to 0.06 mol, still more preferably from 0.03 mol to 0.05 mol, with respect to 1 mol of the nitrile group-containing monomer.

The content of the structural unit derived from a nitrile group-containing monomer is preferably not less than 50% by mole, more preferably not less than 70% by mole, still more preferably not less than 80% by mole, based on the total amount of the resin including the structural unit derived from a nitrile group-containing monomer, which is a binder. A higher content of the structural unit derived from a nitrile group-containing monomer is likely to further improve the swelling resistance against electrolyte solutions and the electrochemical stability of the positive electrode during use.

(Current Cutoff Temperature of Positive Electrode)

The current cutoff temperature of the positive electrode is preferably set to be from 70° C. to 160° C., more preferably set to be from 90° C. to 120° C. By setting the current cutoff temperature to be from 70° C. to 160° C., the current can be cut off to suppress heat generation in the event of abnormality in the lithium ion secondary battery itself or various devices mounted with the lithium ion secondary battery, and the power supply and the like from the lithium ion secondary battery to such various devices can thereby be stopped, so that high safety is attained. Further, when the current cutoff temperature is set to be from 90° C. to 120° C., there is an advantage that the current can be surely cut off in the event of abnormality (e.g., overcharging) with no malfunction in normal use. The current cutoff temperature is dependent on the melting point (Tm) of the polyolefin particles. When the current cutoff temperature is set to be from 90° C. to 120° C., it is preferred to use polyethylene particles as the polyolefin particles.

The current cutoff temperature is defined as the temperature at which the rate of increase in direct-current resistance from the direct-current resistance of the battery at 25° C. is 110% or higher.

The positive electrode active material layer can be formed by, for example, coating a positive electrode mixture paste on the positive electrode current collector, drying and then, as required, press-rolling. The positive electrode mixture paste can be prepared by adding the positive electrode active material to a dispersion medium along with the conductive particles, the polyolefin particles, the binder and the like, and then mixing the resultant. As the dispersion medium, for example, N-methyl-2-pyrrolidone (NMP), tetrahydrofuran, or dimethylformamide can be used. As the dispersion medium, it is preferred to select one which dissolves or disperses the binder but does not dissolve the polyolefin particles.

When the polyolefin particles are dissolved, it is difficult to obtain the desired PTC function. Some polyolefin particles are hardly soluble in both organic solvents and water and, when such polyolefin particles are used, it is not necessary to select the type of the dispersion medium.

In the formation of the positive electrode active material layer containing the above-described positive electrode active material, conductive particles, polyolefin particles and binder in the lithium ion secondary battery of the disclosure, an excessively high packing density of the positive electrode active material layer makes a non-aqueous electrolyte less likely to infiltrate into the positive electrode active material layer and diffusion of lithium ions during high-current charging and discharging is thus retarded, as a result of which the cycle characteristics may be deteriorated. On the other hand, when the packing density of the positive electrode active material layer is low, the contact between the positive electrode active material and the conductive particles is no longer sufficiently secured, so that the electrical resistance may be increased and the discharge rate may be reduced. Accordingly, the packing density of the positive electrode active material layer is preferably in a range of from 2.2 g/cm³ to 2.8 g/cm³, more preferably in a range of from 2.3 g/cm³ to 2.7 g/cm³, still more preferably in a range of from 2.4 g/cm³ to 2.6 g/cm³.

When the packing density of the positive electrode active material layer is 2.8 g/cm³ or less, a non-aqueous electrolyte easily infiltrates into the positive electrode active material layer and diffusion of lithium ions during high-current charging and discharging is thus accelerated, so that the cycle characteristics tend to be improved. Meanwhile, when the packing density of the positive electrode active material layer is 2.2 g/cm³ or higher, since the contact between the positive electrode active material and the conductive particles is sufficiently secured, the electrical resistance is reduced, so that the discharge rate property tends to be improved.

Further, in the formation of the positive electrode active material layer in the lithium ion secondary battery of the disclosure by coating the positive electrode mixture paste on the positive electrode current collector, a large coating amount of the positive electrode mixture paste, which leads to the formation of an excessively thick positive electrode active material layer, causes unevenness in the reaction along the thickness direction during high-current charging and discharging, as a result of which the cycle characteristics tend to be deteriorated. On the other hand, when the positive electrode mixture paste is coated in a small amount and an excessively thin positive electrode active material layer is thereby formed, a sufficient battery capacity tends not to be obtained. Accordingly, the amount of the positive electrode mixture paste to be coated on the positive electrode current collector (coating amount on one side) is preferably in a range of from 50 g/m² to 300 g/m², more preferably in a range of from 80 g/m² to 250 g/m², still more preferably in a range of from 100 g/m² to 220 g/m², in terms of the solid content of the positive electrode mixture paste. It is noted here that “solid content of the positive electrode mixture paste” refers to the components of the positive electrode mixture paste from which volatile components (e.g., dispersion medium) are excluded.

Moreover, from the standpoints of discharge capacity and discharge rate, the thickness of the positive electrode active material layer is preferably from 30 μm to 200 μm, more preferably from 50 μm to 180 μm, still more preferably from 70 μm to 150 μm.

(Negative Electrode)

The negative electrode contains a negative electrode current collector and a negative electrode active material layer. As the negative electrode current collector, any negative electrode current collector that is commonly used in the field of lithium ion secondary batteries can be used. Specific examples thereof include sheets and foils that contain stainless steel, nickel, copper or the like. The thickness of the sheet or foil is not particularly restricted; however, it is, for example, preferably from 1 μm to 500 μm, more preferably from 1.5 μm to 200 μm, still more preferably from 2 μm to 100 μm, particularly preferably from 5 m to 50 μm. The negative electrode active material layer is formed on one or both surfaces in the thickness direction of the negative electrode current collector and contains a negative electrode active material. As required, the negative electrode active material layer may further contain a binder, conductive particles, a thickening agent or the like.

As the negative electrode active material, any material that is capable of occluding and releasing lithium ions and commonly used in the field of lithium ion secondary batteries can be used. Examples thereof include metallic lithium, lithium alloys, intermetallic compounds, carbon materials, organic compounds, inorganic compounds, metal complexes, and organic polymer compounds. These negative electrode active materials may be used singly, or in combination of two or more kinds thereof. Thereamong, a carbon material is preferred. Examples of the carbon material include graphites, such as natural graphite (e.g., flake graphite) and artificial graphite; carbon blacks, such as acetylene black, Ketjen black, channel black, furnace black, lamp black, and thermal black; and carbon fibers. The volume-average particle size of the carbon material is preferably from 0.1 μm to 60 μm, more preferably from 0.5 μm to 30 μm. Further, the BET specific surface area of the carbon material is preferably from 1 m²/g to 10 m²/g. Among the carbon materials, from the standpoint of further improving the battery properties (e.g., discharge capacity), a graphite in which the distance between carbon hexagonal planes (d₀₀₂) is from 3.35 Å to 3.40 Å (from 0.335 nm to 0.340 nm) as determined by wide-angle X-ray diffractometry and which has a crystallite (Lc) size in the c-axis direction of not smaller than 100 Å (10 nm) is particularly preferred.

Further, among the carbon materials, from the standpoint of further improving the cycle characteristics and the safety, an amorphous carbon in which the distance between carbon hexagonal planes (d₀₀₂) is from 3.5 Å to 3.95 Å (from 0.350 nm to 0.395 nm) as determined by wide-angle X-ray diffractometry is especially preferred. Examples of the amorphous carbon include easily graphitizable carbon and hardly graphitizable carbon.

In the present specification, the average particle size of the negative electrode active material is a value at which the cumulative particle size from the small diameter side reaches 50% (median diameter (D50)) in a volume-based particle size distribution determined using a laser diffraction-type particle size distribution analyzer (e.g., SALD-3000J manufactured by Shimadzu Corporation) for a sample dispersed in purified water containing a surfactant.

The BET specific surface area can be measured, for example, based on the nitrogen adsorption capacity in accordance with JIS Z8830:2013. As an evaluation apparatus, for example, AUTOSORB-1 (trade name) manufactured by Quantachrome Instruments can be employed. In the measurement of the BET specific surface area, since moisture adsorbed on the sample surface and in the sample structure is believed to influence the gas adsorption capacity, it is preferred to first perform a pretreatment for moisture removal by heating.

In this pretreatment, a measurement cell loaded with 0.05 g of a measurement sample is decompressed to 10 Pa or less using a vacuum pump and subsequently heated and retained at 110° C. for at least three hours, after which the measurement cell is naturally cooled to normal temperature (25° C.) with the decompressed state being maintained. After the pretreatment, the measurement is performed at an evaluation temperature of 77K in an evaluation pressure range of less than 1 in terms of relative pressure (equilibrium pressure with respect to the saturated vapor pressure).

Examples of conductive particles that may be used in the negative electrode active material layer include the same conductive particles as those exemplified above for the positive electrode active material layer. Further, as the binder in the negative electrode active material layer, any binder that is commonly used in the field of lithium ion secondary batteries can be used, and examples thereof include polyethylenes, polypropylenes, polytetrafluoroethylenes, polyvinylidene fluorides, styrene-butadiene rubbers, and acrylic rubbers.

In the negative electrode active material layer, from the standpoints of the stability and the coatability of a negative electrode mixture paste, a thickening agent may be used as well. As the thickening agent, any thickening agent that is commonly used in the field of lithium ion secondary batteries can be used.

Examples of such a thickening agent that may be used in the negative electrode active material layer include carboxymethyl cellulose (CMC). The negative electrode active material layer can be formed by, for example, coating a negative electrode mixture paste on the surface of the negative electrode current collector, drying and then, as required, press-rolling. The negative electrode mixture paste can be prepared by adding the negative electrode active material to a dispersion medium along with, as required, the binder, the conductive particles, the thickening agent and the like, and then mixing the resultant. As the dispersion medium, for example, N-methyl-2-pyrrolidone (NMP) or water can be used.

The negative electrode active material layer may further contain polyolefin particles, and examples thereof include the same polyolefin particles as those exemplified above for the positive electrode active material layer.

(Electrolyte)

Examples of the electrolyte include liquid non-aqueous electrolytes (electrolyte solutions), gel non-aqueous electrolytes, and solid electrolytes (e.g., solid polymer electrolytes). A liquid non-aqueous electrolyte contains a solute (supporting salt) and a non-aqueous solvent and further contains, as required, various additives. The solute is usually soluble in the non-aqueous solvent. Such a liquid non-aqueous electrolyte is, for example, impregnated into a separator.

As the solute, any solute that is commonly used in this field can be used, and examples thereof include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, chloroborane lithium, borates, and imide salts. Examples of the borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzene sulfonic acid-O,O′)borate. Examples of the imide salts include lithium bis(trifluoromethane)sulfonimide ((CF₃SO₂)₂NLi), lithium trifluoromethane sulfonyl(nonafluorobutane)sulfonimide ((CF₃SO₂)(C₄F₉SO₂)NLi), and lithium bis(pentafluoroethanesulfonyl)imide ((C₂F₅SO₂)₂NLi). These solutes may be used singly, or in combination of two or more kinds thereof as required. The amount of the solute(s) dissolved in the non-aqueous solvent is preferably from 0.5 mol/L to 2 mol/L.

As the non-aqueous solvent, any non-aqueous solvent that is commonly used in this field can be used, and examples thereof include cyclic carbonic acid esters, chain carbonic acid esters, and cyclic carboxylic acid esters. Examples of the cyclic carbonic acid esters include propylene carbonate (PC) and ethylene carbonate (EC). Examples of the chain carbonic acid esters include diethyl carbonate (DEC), ethylmethyl carbonate (EMC), and dimethyl carbonate (DMC). Examples of the cyclic carboxylic acid esters include γ-butyrolactone (GBL) and γ-valerolactone (GVL). These non-aqueous solvents may be used singly, or in combination of two or more kinds thereof as required.

From the standpoint of further improving the battery properties, the non-aqueous solvent preferably contains vinylene carbonate (VC).

When the non-aqueous solvent contains vinylene carbonate (VC), the content ratio thereof is preferably from 0.1% by mass to 2% by mass, more preferably from 0.2% by mass to 1.5% by mass, with respect to the total amount of the non-aqueous solvent.

(Separator)

The separator is arranged between the positive electrode and the negative electrode.

A first separator used in the disclosure has a thermal shrinkage rate of 30% or less at 160° C.

A second separator used in the disclosure contains a porous substrate and inorganic particles, and the porous substrate is a layered body including a polypropylene resin and a polyethylene resin disposed alternately in layers.

A third separator used in the disclosure contains a woven or nonwoven fabric of a polyethylene terephthalate resin, and inorganic particles.

The first separator, the second separator and the third separator may be hereinafter collectively referred to as “the separator of the disclosure”.

The thermal shrinkage rate of the first separator at 160° C. may be 30% or less, preferably 25% or less, more preferably 23% or less, still more preferably 20% or less. With the thermal shrinkage rate of the first separator at 160° C. being 30% or less, since the separator maintains its shape even when the battery temperature increases in an overcharged state and the separator is thereby heat-shrunk, the occurrence of a short circuit between the positive electrode and the negative electrode can be inhibited.

The thermal shrinkage rate is not restricted for the second and the third separators, and it may be, for example, 30% or less, preferably 25% or less, more preferably 23% or less, still more preferably 20% or less.

The lower limit value of the thermal shrinkage rate at 160° C. is preferably 0%, however, from the practical standpoint, it is 1% or higher.

In the present specification, the thermal shrinkage rate at 160° C., which is also referred to as “area shrinkage rate”, is determined as follows after cutting out the subject separator into a size of 50 mm (MD: Machine Direction)×50 mm (TD: Transverse Direction), heating this separator on a glass substrate for 1 hour in a thermostat chamber adjusted at 160° C., and then measuring the area of the thus heated separator:

Thermal shrinkage rate (area shrinkage rate) (%)=(Area before heating−Area after heating)/Area before heating×100

The Gurley value [sec/100 cc] of the separator of the disclosure is preferably 1,000 sec/100 cc or less, more preferably 800 sec/100 cc or less, still more preferably 600 sec/100 cc or less, yet still more preferably 300 sec/100 cc or less, particularly preferably 200 sec/100 cc or less, extremely preferably 100 sec/100 cc or less.

Further, the Gurley value [sec/100 cc] of the separator of the disclosure is preferably from 1 sec/100 cc to 1,000 sec/100 cc, more preferably from 1 sec/100 cc to 800 sec/100 cc, still more preferably from 1 sec/100 cc to 600 sec/100 cc, yet still more preferably from 1 sec/100 cc to 300 sec/100 cc, particularly preferably from 1 sec/100 cc to 200 sec/100 cc, extremely preferably from 1 sec/100 cc to 100 sec/100 cc.

When the Gurley value of the separator of the disclosure is in a range of from 1 sec/100 cc to 1,000 sec/100 cc, favorable ion permeability and excellent discharge rate property tends to be obtained. Further, when the Gurley value of the separator of the disclosure is in a range of from 1 sec/100 cc to 300 sec/100 cc, more favorable ion permeability and superior discharge rate property tends to be obtained.

The Gurley value is air resistance determined by the Gurley test method and represents the difficulty of an ion to pass through a separator in the thickness direction. A small Gurley value means that an ion easily passes through the separator, while a large Gurley value means that an ion hardly passes through the separator.

In the present specification, the Gurley value is a value determined in accordance with the Gurley test method (JIS P8117:2009).

A fourth lithium ion secondary battery of the disclosure is a lithium ion secondary battery which includes: a positive electrode; a negative electrode; a separator; and an electrolyte, wherein the positive electrode includes a current collector and a positive electrode active material layer formed on the current collector, the positive electrode active material layer contains a positive electrode active material, polyolefin particles, conductive particles and a binder, the separator has a Gurley value of 300 sec/100 cc or less and includes a porous substrate and inorganic particles, and the porous substrate contains a polyester resin.

The thermal shrinkage rate is not restricted for the separator of the fourth lithium ion secondary battery, and it may be, for example, 30% or less, preferably 25% or less, more preferably 23% or less, still more preferably 20% or less.

The separator of the disclosure may include a porous substrate and inorganic particles.

Examples of a resin contained in the porous substrate include olefin-based resins, such as a polypropylene resin and a polyethylene resin; fluorocarbon resins, such as a polytetrafluoroethylene; polyester resins, such as polyethylene terephthalate resin (PET); an aramid resin; a polyacrylonitrile resin; a polyvinyl alcohol resin; and a polyimide resin. As the resin contained in the porous substrate, these resins may be used singly, or in combination of two or more kinds thereof as required.

In one mode, the separator includes a porous substrate and inorganic particles, and the porous substrate contains two or more different kinds of resin selected from the group consisting of a polypropylene resin, a polyethylene resin, a polyvinyl alcohol resin, a polyethylene terephthalate resin, a polyacrylonitrile resin, and an aramid resin. The porous substrate preferably contains a polyethylene resin and a polypropylene resin.

Further, in other mode, the separator includes a porous substrate and inorganic particles, and the porous substrate may contain a polyester resin. Among the polyester resin that may be contained in the porous substrate, a polyethylene terephthalate resin (PET) is suitable for the porous substrate since it has excellent heat resistance and electrical insulation. When the porous substrate contains a polyethylene terephthalate resin, it is preferred to use a woven or nonwoven fabric of the polyethylene terephthalate resin as the porous substrate. In the present specification, the term “nonwoven fabric” means a sheet-form article formed by intertwining fibers without weaving.

Meanwhile, when the porous substrate contains two or more kinds of resins, the porous substrate may be a layered body including the two or more kinds of resins disposed alternately in layers. In the disclosure, when the porous substrate is a layered body including two or more kinds of resins disposed in layers, the porous substrate preferably has a bilayer structure or a three-layer structure.

The method of producing the porous substrate is not particularly restricted and may be selected from known methods. In the disclosure, the porous substrate may be a woven or a nonwoven fabric, and is preferably a nonwoven fabric.

The melting point of the porous substrate is preferably 120° C. or higher, more preferably 140° C. or higher, still more preferably 160° C. or higher. When the melting point is 120° C. or higher, the separator has a shut-down function and is also capable of inhibiting a short circuit inside the battery. The upper limit of the melting point of the porous substrate is not particularly restricted and, from the practical standpoint, the melting point of the porous substrate is preferably 300° C. or lower.

The term “melting point” used herein means the melting temperature that is measured in accordance with JIS K7121 using a differential scanning calorimeter (DSC). Specifically, the melting point is determined by differential scanning calorimetry of 3 mg to 5 mg of a sample tightly sealed in an aluminum pan, which is performed under a nitrogen atmosphere at a heating rate of 10° C./min and a flow rate of 20±5 ml/min in a measurement temperature range of from 25° C. to 350° C. using a differential scanning calorimeter (DSC7, manufactured by Perkin Elmer Co., Ltd.). From the results obtained by the differential scanning calorimetry, the temperature at which an energy shift occurs in association with phase transition (endothermic reaction peak) is taken as the melting point.

Examples of the inorganic particles include particles of aluminum oxide (Al₂O₃), silicon oxide (SiO₂), titanium oxide (TiO₂), barium titanate (BaTiO₃), ZrO₂ (zirconia), and boehmite. These inorganic particles may be used singly, or in combination of two or more kinds thereof as required.

From the standpoints of electrical insulation or electrical stability, the inorganic particles are preferably made of at least one of aluminum oxide (hereinafter, also referred to as “alumina”) or silicon oxide (hereinafter, also referred to as “silica”).

The inorganic particles have a function of protecting the porous substrate from undergoing thermal deformation or thermal shrinkage while maintaining the shut-down function of the porous substrate melted by an abnormally high temperature of the battery. The inorganic particles may be applied onto the surface of the porous substrate, or may be impregnated into the pores of the porous substrate.

The separator includes a layer containing the inorganic particles on one surface of the porous substrate, and the separator may be arranged such that the layer containing the inorganic particles faces the positive electrode. The layer containing the inorganic particles can function as a heat-resistant layer that protects the porous substrate from undergoing thermal deformation or thermal shrinkage.

When two or more kinds of resins are used in the porous substrate, a mode in which two different kinds of resins are alternately disposed in layers may be adopted, and the porous substrate may be a layered body including a polypropylene resin and a polyethylene resin disposed alternately in layers.

Further, when a porous substrate having a three-layer structure is used in the separator, the combination of layers in the porous substrate having a three-layer structure is preferably a combination of porous films that contain resins having different melting temperatures are disposed on one another in layers, more preferably a combination of olefin-based resin-containing porous substrates, still more preferably a porous substrate in which a polypropylene resin, a polyethylene resin and a polypropylene resin are sequentially disposed in layers in the order mentioned (hereinafter, may also be referred to as “PP/PE/PP”). It is preferred to adopt any one of the above-described combinations for the porous substrate since this allows the separator to have a shut-down function and excellent electrochemical stability.

In the disclosure, the porous substrate may have a structure in which PP, PE and PP are sequentially disposed in layers(PP/PE/PP), and a separator produced by a method of adhering aluminum oxide or silicon oxide to the porous substrate having a PP/PE/PP structure may be used.

According to this three-layer structure, a polyethylene resin-containing layer is sandwiched between polypropylene resin-containing layers; therefore, even when the polyethylene resin-containing layer is melted, the inorganic particles exiting on the porous substrate surface or being impregnated into the pores exhibit the function as a heat-resistant layer and maintain the function of isolating the positive electrode and the negative electrode. In addition, since the polyethylene resin does not bleed out even when it is melted, the shut-down function is efficiently exerted. Moreover, when the separator is exposed to a high temperature, since the polypropylene resin melts in a temperature range of from 160° C. to 170° C. and the polyethylene resin and the polypropylene resin block the voids of the porous substrate, the separator exhibits the shut-down function more safely.

The average particle size (D50) of the inorganic particles is preferably from 0.1 μm to 10 μm, more preferably from 0.2 μm to 9 μm, still more preferably from 0.3 μm to 8 μm.

As long as the average particle size of the inorganic particles is in this range, favorable adhesion is attained between the inorganic particles and the porous substrate and, even when the battery temperature is increased, the separator has a low thermal shrinkage rate.

In the present specification, the average particle size of the inorganic particles is a value at which the cumulative particle size from the small diameter side reaches 50% (median diameter (D50)) in a volume-based particle size distribution determined using a laser diffraction-type particle size distribution analyzer (e.g., SALD-3000J manufactured by Shimadzu Corporation) for a sample dispersed in purified water containing a surfactant.

In the separator of the disclosure, from the standpoints of the thermal shrinkage rate, flexibility and the like of the separator, the mass-based ratio (α1:β1) between the content of the inorganic particles (α1) and the content of the resins such as a polyethylene terephthalate resin (β1) is preferably in a range of from 1:50 to 20:1, more preferably in a range of from 1:25 to 10:1, still more preferably in a range of from 1:5 to 4:1.

In cases where the inorganic particles are coated on the porous substrate, from the standpoints of the thermal shrinkage rate, flexibility and the like of the separator, the ratio (α2:β2) between the thickness of a layer of the inorganic particles (hereinafter, referred to as “inorganic particle layer”) (α2) and the thickness of the porous substrate (β2) is preferably in a range of from 1:100 to 10:1, more preferably in a range of from 1:50 to 5:1, still more preferably in a range of from 1:10 to 2:1.

In one mode, the thickness of the separator is preferably in a range of from 5 μm to 100 more preferably from 7 μm to 50 μm, still more preferably from 15 μm to 30 μm. In other mode, the thickness of the separator is preferably in a range of from 5 μm to 100 μm, more preferably in a range of from 13 μm to 70 μm, still more preferably in a range of from 15 μm to 50 μm.

When the thickness of the separator is in a range of from 5 μm to 100 μm, a high volume energy density and excellent safety can be attained while maintaining the ion permeability.

(Lithium Ion Secondary Battery)

An embodiment in which the disclosure is applied to a laminate-type battery is described below.

A laminate-type lithium ion secondary battery can be produced by, for example, the following manner. First, a positive electrode and a negative electrode are cut into rectangular shapes, and a tab is welded to each of the electrodes to prepare positive electrode and negative electrode terminals. Subsequently, a separator is arranged between the positive electrode and the negative electrode to prepare an electrode layered body, and this electrode layered body is directly housed in an aluminum laminate package. The positive electrode and negative electrode terminals are then drawn out of the aluminum laminate package, and the aluminum laminate package is tightly sealed. Thereafter, an electrolyte solution is injected into the aluminum laminate package, and an opening of the aluminum laminate package is tightly sealed, whereby a lithium ion secondary battery is obtained.

Next, an embodiment in which the invention is applied to an 18650-type cylindrical lithium ion secondary battery is described referring to the drawing.

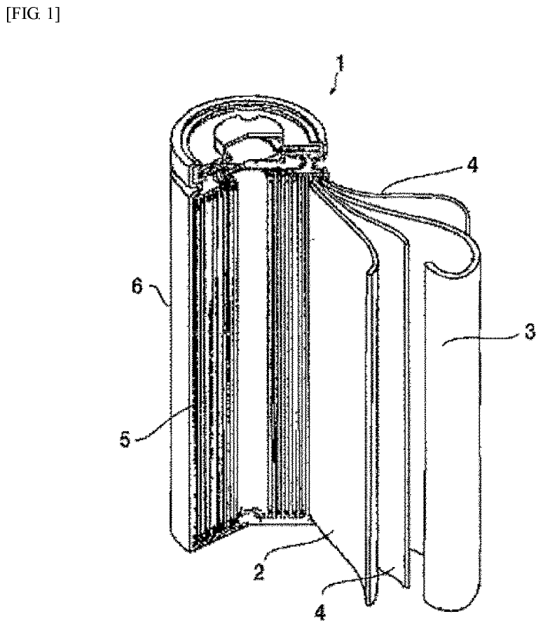

FIG. 1 is a cross-sectional view of a lithium ion secondary battery to which the disclosure is applied.

As illustrated in FIG. 1, a lithium ion secondary battery 1 of the disclosure has a closed-bottom cylindrical battery container 6 made of nickel-plated steel. In the battery container 6, an electrode assembly 5 in which a positive electrode plate 2 and a negative electrode plate 3, which are both in a strip form, are spirally wound in a cross-section via a separator 4 is housed. The separator 4 is configured to have, for example, a width of 58 mm and a thickness of 30 μm. On the upper end surface of the electrode assembly 5, a ribbon-form positive electrode tab terminal, which is made of aluminum and fixed with the positive electrode plate 2 at one end, protrudes. The other end of the positive electrode tab terminal is bonded by ultrasonic welding to the lower surface of a disk-shaped battery cover, which is arranged on the upper side of the electrode assembly 5 and functions as a positive electrode external terminal. Meanwhile, on the lower end surface of the electrode assembly 5, a ribbon-form negative electrode tab terminal, which is made of copper and fixed with the negative electrode plate 3 at one end, protrudes. The other end of the negative electrode tab terminal is bonded by resistance welding to the inner bottom part of the battery container 6. Accordingly, the positive electrode tab terminal and the negative electrode tab terminal protrude on the opposite sides from each other on the respective end surfaces of the electrode assembly 5. It is noted here that an insulation coating (not illustrated) is applied to the entirety of the outer circumferential surface of the electrode assembly 5. The battery cover is caulk-fixed on top of the battery container 6 via an insulating resin gasket. Therefore, the inside of the lithium ion secondary battery 1 is hermetically sealed. Further, an electrolyte solution (not illustrated) is injected into the battery container 6.

### EXAMPLES

The invention is described below by way of examples thereof. It is noted here, however, that the invention is not restricted to the following examples.

[Synthesis of Resin Containing Structural Unit Derived From Nitrile Group-Containing Monomer]

To a 0.5-L separable flask equipped with a stirrer, a thermometer and a condenser, 397.2 g of purified water (manufactured by Wako Pure Chemical Industries, Ltd.) was added, and the inside of the system was purged with nitrogen and then heated to 72.0° C. After confirming that the water temperature in the system reached 72.0° C., 347.0 mg of ammonium persulfate (polymerization initiator, manufactured by Wako Pure Chemical Industries, Ltd.) was dissolved in 2.5 g of purified water, and the resultant was added to the system and then stirred at 250 rpm (rotation/min). Subsequently, 39.3 g (0.74 mol) of acrylonitrile (manufactured by Wako Pure Chemical Industries, Ltd.), 1.4 g (0.006 mol) of methoxy triethylene glycol acrylate (NK ESTER AM-30G, manufactured by Shin-Nakamura Chemical Co., Ltd.) and 2.1 g (0.029 mol) of acrylic acid (manufactured by Wako Pure Chemical Industries, Ltd.) were added dropwise to the system over a period of 2 hours, and these materials were allowed to react for 1 hour.

Next, 420 mg of ammonium persulfate (polymerization initiator, manufactured by Wako Pure Chemical Industries, Ltd.) was dissolved in 7.8 g of purified water, and the resultant was added to the system and allowed to react for 1 hour. Subsequently, the temperature of the reaction was raised to 92.0° C., and the reaction was allowed to proceed for one hour. Then, after dissolving 210 mg of ammonium persulfate (polymerization initiator, manufactured by Wako Pure Chemical Industries, Ltd.) in 1.5 g of purified water and adding the resultant to the system, the reaction was allowed to proceed for one hour. In these steps, the inside of the system was maintained to have a nitrogen atmosphere, and stirring was continued at 250 rpm (rotation/min). After cooling the system to room temperature (25° C.), the resulting reaction solution was suction-filtered to separate a precipitated resin by filtration. The precipitated resin thus separated by filtration was washed with 1,000 g of purified water (manufactured by Wako Pure Chemical Industries, Ltd.). Then, the washed resin was dried for 24 hours in a vacuum dryer set at 60° C. and 150 Pa to obtain a resin including a structural unit derived from a nitrile group-containing monomer. To a 0.5-L separable flask equipped with a stirrer, a thermometer and a condenser, 423 g of NMP was added and, after heating the system to 100±5° C., 27 g of the thus obtained resin including a structural unit derived from a nitrile group-containing monomer was further added, followed by 5-hour stirring at 300 rpm (rotation/min), whereby an NMP solution was obtained.

### Experimental Example 1A

### [Preparation of Positive Electrode Plate]

A layered lithium-nickel-manganese-cobalt composite oxide (positive electrode active material, BET specific surface area: 0.4 m²/g, average particle size (d50): 6.5 μm), acetylene black as conductive particles (trade name: HS-100, average particle size: 48 nm (value listed on a catalog of Denka Co., Ltd.), manufactured by Denka Co., Ltd.), polyolefin particles (polyethylene particles, trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP), and the above-synthesized resin including a structural unit derived from a nitrile group-containing monomer (binder) were mixed at a mass ratio (positive electrode active material:conductive particles:polyolefin particles:binder) of 88.0:4.5:6.5:1.0 in terms of solid content, and the resulting mixture was sufficiently dispersed in N-methyl-2-pyrrolidone (solvent, manufactured by Wako Pure Chemical Industries, Ltd.) to prepare a positive electrode mixture paste. Then, both sides of a 20 μm-thick aluminum foil serving as a positive electrode current collector were coated with the thus obtained positive electrode mixture paste in a substantially uniform and homogeneous manner. Thereafter, the thus coated aluminum foil was subjected to a drying treatment and pressed to a prescribed density. The positive electrode mixture density (packing density of the positive electrode active material layer) was set at 2.60 g/cm³, and the coating amount of the positive electrode mixture paste on each side was set at 140 g/m² in terms of the solid content of the positive electrode mixture paste.

[Preparation of Negative Electrode Plate]

As a binder, polyvinylidene fluoride (PVDF) was added to an easily-graphitizable carbon (negative electrode active material, d002: 0.35 nm, average particle size (d50): 18 μm). These materials were mixed such that a mass ratio (negative electrode active material:binder) of 92:8 in terms of solid content was attained and, as a dispersion solvent, N-methyl-2-pyrrolidone (NMP) (manufactured by Wako Pure Chemical Industries, Ltd.) was added to the resulting mixture, followed by kneading, whereby a negative electrode mixture paste was prepared. Then, both sides of a 10 μm-thick press-rolled copper foil serving as a negative electrode current collector were coated with the thus obtained negative electrode mixture paste in a substantially uniform and homogeneous manner.

The negative electrode mixture density (packing density of the negative electrode active material layer) was set at 1.15 g/cm³, and the coating amount of the negative electrode mixture paste on each side was set at 90 g/m² in terms of the solid content of the negative electrode mixture paste.

[Battery Production] Production of 18650-Type Lithium Ion Secondary Battery

A separator prepared by coating a porous substrate of 25 μm in thickness, 58.5 mm in width and 875 mm in length, which had three layers of polypropylene, polyethylene and polypropylene, with silica (this separator is hereinafter also referred to as “coated-type PP/PE/PP separator” or “PP/PE/PP separator”) was sandwiched between the above-prepared positive electrode plate and negative electrode plate, and the resultant was wound to prepare a wound-type electrode assembly. In this process, the wound-type electrode assembly was designed such that the resulting battery would have a capacity of 900 mAh. This wound-type electrode assembly was inserted into a battery container, and a negative electrode tab terminal, which had been welded to the negative electrode current collector in advance, was welded to the container bottom. Then, a positive electrode tab terminal, which had been welded to the positive electrode current collector in advance, was welded to a positive electrode external terminal in an electrically connected manner, after which a positive electrode cap was arranged on top of the container, and an insulating gasket was inserted therebetween. Subsequently, 6 ml of an electrolyte solution (manufactured by Ube Industries, Ltd.), which was obtained by adding vinylene carbonate in an amount of 0.8% by mass with respect to the whole amount of a mixed solution containing 1.2 M of LiPF₆ (ethylene carbonate:ethylmethyl carbonate:dimethyl carbonate=2:2:3 (volume ratio)), was injected into the battery container. Thereafter, the upper part of the battery container was caulked to tightly seal the battery container, whereby an 18650-type lithium ion secondary battery was produced.

### Experimental Example 2A

An 18650-type lithium ion secondary battery was produced in the same manner as in Experimental Example 1A, except that the polyolefin particles used in the positive electrode plate were changed from the NMP dispersion of the polyethylene particles (trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP) to an NMP dispersion of polyethylene particles (trade name: CHEMIPEARL (registered trademark) W308, average particle size: 6.0 μm (value listed on a catalog of Mitsui Chemicals, Inc.), melting point: 132° C. (value listed on a catalog of Mitsui Chemicals, Inc.), manufactured by Mitsui Chemicals, Inc.; the dispersion medium was replaced with NMP).

### Experimental Example 3A

An 18650-type lithium ion secondary battery was produced in the same manner as in Experimental Example 1A, except that the polyolefin particles used in the positive electrode plate were changed from the NMP dispersion of the polyethylene particles (trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP) to an NMP dispersion of polyethylene particles (trade name: CHEMIPEARL (registered trademark) WP100, average particle size: 1.0 μm (value listed on a catalog of Mitsui Chemicals, Inc.), melting point: 148° C. (value listed on a catalog of Mitsui Chemicals, Inc.), manufactured by Mitsui Chemicals, Inc.; the dispersion medium was replaced with NMP).

### Experimental Example 4A

### [Preparation of Positive Electrode Plate]

A layered lithium-nickel-manganese-cobalt composite oxide (positive electrode active material, BET specific surface area: 0.4 m²/g, average particle size (d50): 6.5 μm), acetylene black as conductive particles (trade name: HS-100, average particle size: 48 nm (value listed on a catalog of Denka Co., Ltd.), manufactured by Denka Co., Ltd.), and polyvinylidene fluoride (PVDF) as a binder were mixed at a mass ratio (positive electrode active material:conductive particles:binder) of 88.0:4.5:7.5 in terms of solid content, and NMP was further added to the resulting mixture for viscosity adjustment, whereby a positive electrode mixture paste was prepared. Then, both sides of a 20 μm-thick aluminum foil serving as a positive electrode current collector were coated with the thus obtained positive electrode mixture paste in a substantially uniform and homogeneous manner. Thereafter, the thus coated aluminum foil was subjected to a drying treatment and pressed to a prescribed density. The positive electrode mixture density (packing density of the positive electrode active material layer) was set at 2.60 g/cm³, and the coating amount of the positive electrode mixture paste on each side was set at 140 g/m² in terms of the solid content of the positive electrode mixture paste.

[Preparation of Negative Electrode Plate]

As a binder, polyvinylidene fluoride (PVDF) was added to an easily-graphitizable carbon (negative electrode active material, d002: 0.35 nm, average particle size (d50): 18 μm). These materials were mixed such that a mass ratio (negative electrode active material:binder) of 92:8 in terms of solid content was attained and, as a dispersion solvent, N-methyl-2-pyrrolidone (NMP) was added to the resulting mixture, followed by kneading, whereby a negative electrode mixture paste was prepared. Then, both sides of a 10 μm-thick press-rolled copper foil serving as a negative electrode current collector were coated with the thus obtained negative electrode mixture paste in a substantially uniform and homogeneous manner. The negative electrode mixture density (packing density of the negative electrode active material layer) was set at 1.15 g/cm³, and the coating amount of the negative electrode mixture paste on each side was set at 90 g/m² in terms of the solid content of the negative electrode mixture paste.

[Battery Production] Production of 18650-Type Lithium Ion Secondary Battery

A coated-type PP/PE/PP separator of 25 μm in thickness, 58.5 mm in width and 875 mm in length was sandwiched between the above-prepared positive electrode plate and negative electrode plate, and the resultant was wound to prepare a wound-type electrode assembly. In this process, the wound-type electrode assembly was designed such that the resulting battery would have a capacity of 900 mAh. This wound-type electrode assembly was inserted into a battery container, and a negative electrode tab terminal, which had been welded to the negative electrode current collector in advance, was welded to the container bottom. Then, a positive electrode tab terminal, which had been welded to the positive electrode current collector in advance, was welded to a positive electrode external terminal in an electrically connected manner, after which a positive electrode cap was arranged on top of the container, and an insulating gasket was inserted therebetween. Subsequently, 6 ml of an electrolyte solution (manufactured by Ube Industries, Ltd.), which was obtained by adding vinylene carbonate in an amount of 0.8% by mass with respect to the whole amount of a mixed solution containing 1.2 M (mol/L) of LiPF₆ (ethylene carbonate:ethylmethyl carbonate:dimethyl carbonate=2:2:3 (volume ratio)), was injected into the battery container. Thereafter, the upper part of the battery container was caulked to tightly seal the battery container, whereby an 18650-type lithium ion secondary battery was produced.

### Experimental Example 5A

An 18650-type lithium ion secondary battery was produced in the same manner as in Experimental Example 1A, except that the coated-type PP/PE/PP separator of 25 μm in thickness and 58.5 mm in width was changed to a polyethylene separator of 30 μm in thickness and 58.5 mm in width (hereinafter, also referred to as “PE separator”).

### Experimental Example 6A

An 18650-type lithium ion secondary battery was produced in the same manner as in Experimental Example 4A, except that the coated-type PP/PE/PP separator of 25 μm in thickness and 58.5 mm in width was changed to a polyethylene separator of 30 μm in thickness and 58.5 mm in width (hereinafter, also referred to as “PE separator”).

(Heat Resistance of Separators)

The separators used in Experimental Examples 1A to 6A were each cut out into a size of 50 mm×50 mm, placed on a glass substrate, and then heated for 1 hour in a thermostat chamber adjusted at 160° C. The size of each test piece after the heating was measured, and the thermal shrinkage rate (area shrinkage rate) was calculated using the following formula:

Thermal shrinkage rate (area shrinkage rate) (%)=(Area before heating−Area after heating)/Area before heating×100

[Battery Property (Discharge Capacity)]

For the 18650-type batteries obtained in Experimental Examples 1A to 6A, the discharge capacity at 25° C. was measured as a battery property using a charge-discharge apparatus (trade name: TOSCAT-3200, manufactured by Toyo System Co., Ltd.) under the following charge-discharge conditions. After charging each battery to 4.2 V at a current of 450 mA, the battery was further charged to a current of 9 mA at 4.2 V (constant-current constant-voltage (CCCV) charging). Then, the battery was discharged to 2.7 V at 450 mA (CC discharging). The discharge capacity was measured and evaluated as a battery property based on the following evaluation criteria. It is noted here that an evaluation of “A” was judged as the most excellent battery property, while an evaluation of “C” was judged as the poorest battery property.

A: 890 mAh or higher

B: 880 mAh or higher but lower than 890 mAh

C: lower than 880 mAh

[Safety (Overcharge Property)]

A thermocouple and a ribbon heater were wound on the surface of each of the 18650-type batteries obtained in Experimental Examples 1A to 6A, and a heat insulating material was further wound thereon. After adjusting the surface temperature of each 18650-type battery to be 25° C., the battery was subjected to an overcharging test at a charging rate of 3 CA (2.7 A). The overcharging test was continued until the voltage reached 18 V, and the behavior of each 18650-type battery was observed to evaluate the safety based on the following criteria. It is noted here that an evaluation of “A” was judged as the highest safety, while an evaluation of “C” was judged as the lowest safety.

A: The 18650-type lithium ion secondary battery was neither ruptured nor ignited.

B: The 18650-type lithium ion secondary battery was ruptured or ignited.

C: The 18650-type lithium ion secondary battery was ruptured and ignited.

TABLE 1

| | | Experimental | Experimental | Experimental | Experimental | Experimental | Experimental |
|---|---|---|---|---|---|---|---|
| Item | | Example 1A | Example 2A | Example 3A | Example 4A | Example 5A | Example 6A |
| Positive | Ratio of | 88.0 | 88.0 | 88.0 | 88.0 | 88.0 | 88.0 |
| electrode | positive | | | | | | |
| active | electrode | | | | | | |
| material | active material | | | | | | |
| layer | (% by mass) | | | | | | |
| | Ratio of | 4.5 | 4.5 | 4.5 | 4.5 | 4.5 | 4.5 |
| | conductive | | | | | | |
| | particles | | | | | | |
| | (% by mass) | | | | | | |
| | Ratio of | 6.5 | 6.5 | 6.5 | — | 6.5 | — |
| | polyolefin | | | | | | |
| | particles | | | | | | |
| | (% by mass) | | | | | | |
| | Ratio of binder | 1.0 | 1.0 | 1.0 | 7.5 | 1.0 | 7.5 |
| | (% by mass) | | | | | | |
| | Melting point | 110 | 132 | 148 | — | 110 | — |
| | of polyolefin | | | | | | |
| | particles | | | | | | |
| | (° C.) | | | | | | |
| | Average | 9.5 | 6.0 | 1.0 | — | 9.5 | — |
| | particle size | | | | | | |
| | of polyolefin | | | | | | |
| | particles (μm) | | | | | | |
| Separator | Material | PP/PE/PP | PP/PE/PP | PP/PE/PP | PP/PE/PP | PE | PE |
| | (porous substrate) | separator | separator | separator | separator | separator | separator |
| | Thickness (μm) | 25 | 25 | 25 | 25 | 30 | 30 |
| | Thermal | 18 | 18 | 18 | 18 | 98 | 98 |
| | shrinkage rate | | | | | | |
| | (%) | | | | | | |

| | | | | | | |
|---|---|---|---|---|---|---|
| Battery property | A | A | A | A | A | A |
| (discharge capacity) | | | | | | |
| Safety | A | A | A | C | C | C |
| (overcharge property) | | | | | | |

The batteries of Experimental Examples 1A to 6A all had equivalent battery properties. However, while the batteries of Experimental Examples 1A to 3A, which contained polyolefin particles in the positive electrode active material layer and had a coated-type PP/PE/PP separator, exhibited high safety, the safety was reduced in those batteries of Experimental Examples 4A and 6A that contained no polyolefin particle in the positive electrode active material layer as well as in those batteries of Experimental Examples 5A and 6A that did not have a coated-type PP/PE/PP separator. From these results, it was suggested that a lithium ion secondary battery including a positive electrode, a negative electrode, a separator and an electrolyte, wherein the positive electrode includes a current collector and a positive electrode active material layer formed on the current collector, the positive electrode active material layer contains a positive electrode active material, polyolefin particles, conductive particles and a binder, and the separator has a thermal shrinkage rate of 30% or less at 160° C., is useful as a battery having excellent battery properties and safety. Further, according to the disclosure, the production process is also simple since a PTC function can be imparted to a lithium ion secondary battery without separately arranging a PTC layer.

### Experimental Example 1B

### [Preparation of Positive Electrode Plate]

A layered lithium-nickel-manganese-cobalt composite oxide (positive electrode active material, BET specific surface area: 0.4 m²/g, average particle size (d50): 6.5 μm), acetylene black as conductive particles (trade name: HS-100, average particle size: 48 nm (value listed on a catalog of Denka Co., Ltd.), manufactured by Denka Co., Ltd.), polyolefin particles (polyethylene particles, trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP), and the above-synthesized resin including a structural unit derived from a nitrile group-containing monomer (binder) were mixed at a mass ratio (positive electrode active material:conductive particles:polyolefin particles:binder) of 88.0:4.5:6.5:1.0 in terms of solid content, and the resulting mixture was sufficiently dispersed in N-methyl-2-pyrrolidone (solvent, manufactured by Wako Pure Chemical Industries, Ltd.) to prepare a positive electrode mixture paste. Then, both sides of a 20 μm-thick aluminum foil serving as a positive electrode current collector were coated with the thus obtained positive electrode mixture paste in a substantially uniform and homogeneous manner. Thereafter, the thus coated aluminum foil was subjected to a drying treatment and pressed to a prescribed density. The positive electrode mixture density (packing density of the positive electrode active material layer) was set at 2.60 g/cm³, and the coating amount of the positive electrode mixture paste on each side was set at 140 g/m² in terms of the solid content of the positive electrode mixture paste.

[Preparation of Negative Electrode Plate]

As a binder, polyvinylidene fluoride (PVDF) was added to an easily-graphitizable carbon (negative electrode active material, d002: 0.35 nm, average particle size (d50): 18 μm). These materials were mixed such that a mass ratio (negative electrode active material:binder) of 92:8 in terms of solid content was attained and, as a dispersion solvent, N-methyl-2-pyrrolidone (NMP) (manufactured by Wako Pure Chemical Industries, Ltd.) was added thereto, followed by kneading of the resultant, whereby a negative electrode mixture paste was prepared. Then, both sides of a 10 μm-thick press-rolled copper foil serving as a negative electrode current collector were coated with the thus obtained negative electrode mixture paste in a substantially uniform and homogeneous manner. The negative electrode mixture density (packing density of the negative electrode active material layer) was set at 1.15 g/cm³, and the coating amount of the negative electrode mixture paste on each side was set at 90 g/m² in terms of the solid content of the negative electrode mixture paste.

[Battery Production] Production of 18650-Type Lithium Ion Secondary Battery

A separator prepared by mixing alumina and silica into a polyethylene terephthalate nonwoven fabric of 28 μm in thickness, 58.5 mm in width and 875 mm in length (this separator may be hereinafter also referred to as “polyethylene terephthalate nonwoven fabric”, “PET nonwoven fabric” or “PET separator”) was sandwiched between the above-prepared positive electrode plate and negative electrode plate, and the resultant was wound to prepare a wound-type electrode assembly. In this process, the wound-type electrode assembly was designed such that the resulting battery would have a capacity of 900 mAh. This wound-type electrode assembly was inserted into a battery container, and a negative electrode tab terminal, which had been welded to the negative electrode current collector in advance, was welded to the container bottom. Then, a positive electrode tab terminal, which had been welded to the positive electrode current collector in advance, was welded to a positive electrode external terminal in an electrically connected manner, after which a positive electrode cap was arranged on top of the container, and an insulating gasket was inserted therebetween. Subsequently, 6 ml of an electrolyte solution (manufactured by Ube Industries, Ltd.), which was obtained by adding vinylene carbonate in an amount of 0.8% by mass with respect to the whole amount of a mixed solution containing 1.2 M of LiPF₆ (ethylene carbonate:ethylmethyl carbonate:dimethyl carbonate=2:2:3 (volume ratio)), was injected into the battery container. Thereafter, the upper part of the battery container was caulked to tightly seal the battery. In the above-described manner, an 18650-type lithium ion secondary battery was produced.

### Experimental Example 2B

An 18650-type lithium ion secondary battery was produced in the same manner as in Experimental Example 1B, except that the polyolefin particles used in the positive electrode plate were changed from the NMP dispersion of the polyethylene particles (trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP) to an NMP dispersion of polyethylene particles (trade name: CHEMIPEARL (registered trademark) W308, average particle size: 6.0 μm (value listed on a catalog of Mitsui Chemicals, Inc.), melting point: 132° C. (value listed on a catalog of Mitsui Chemicals, Inc.), manufactured by Mitsui Chemicals, Inc.; the dispersion medium was replaced with NMP).

### Experimental Example 3B

An 18650-type lithium ion secondary battery was produced in the same manner as in Experimental Example 1B, except that the polyolefin particles used in the positive electrode plate were changed from the NMP dispersion of the polyethylene particles (trade name: CHEMIPEARL (registered trademark) W410, average particle size: 9.5 μm (value listed on a catalog of Mitsui Chemicals, Inc.), melting point: 110° C. (value listed on a catalog of Mitsui Chemicals, Inc.), manufactured by Mitsui Chemicals, Inc.; the dispersion medium was replaced with NMP) to an NMP dispersion of polyethylene particles (trade name: CHEMIPEARL (registered trademark) WP100, average particle size: 1.0 μm (value listed on a catalog of Mitsui Chemicals, Inc.), melting point: 148° C. (value listed on a catalog of Mitsui Chemicals, Inc.), manufactured by Mitsui Chemicals, Inc.; the dispersion medium was replaced with NMP).

### Experimental Example 4B

### [Preparation of Positive Electrode Plate]

A layered lithium-nickel-manganese-cobalt composite oxide (positive electrode active material, BET specific surface area: 0.4 m²/g, average particle size (d50): 6.5 μm), acetylene black as conductive particles (trade name: HS-100, average particle size: 48 nm (value listed on a catalog of Denka Co., Ltd.), manufactured by Denka Co., Ltd.), and polyvinylidene fluoride (PVDF) as a binder were mixed at a mass ratio (positive electrode active material:conductive particles:binder) of 88.0:4.5:7.5 in terms of solid content, and NMP was further added to the resulting mixture for viscosity adjustment, whereby a positive electrode mixture paste was prepared. Then, both sides of a 20 μm-thick aluminum foil serving as a positive electrode current collector were coated with the thus obtained positive electrode mixture paste in a substantially uniform and homogeneous manner. Thereafter, the thus coated aluminum foil was subjected to a drying treatment and pressed to a prescribed density. The positive electrode mixture density (packing density of the positive electrode active material layer) was set at 2.60 g/cm³, and the coating amount of the positive electrode mixture paste on each side was set at 140 g/m² in terms of the solid content of the positive electrode mixture paste.

[Preparation of Negative Electrode Plate]

As a binder, polyvinylidene fluoride (PVDF) was added to an easily-graphitizable carbon (negative electrode active material, d002: 0.35 nm, average particle size (d50): 18 μm). These materials were mixed such that a mass ratio (negative electrode active material:binder) of 92:8 in terms of solid content was attained and, as a dispersion solvent, N-methyl-2-pyrrolidone (NMP) was added to the resulting mixture, followed by kneading, whereby a negative electrode mixture paste was prepared. Then, both sides of a 10 μm-thick press-rolled copper foil serving as a negative electrode current collector were coated with the thus obtained negative electrode mixture paste in a substantially uniform and homogeneous manner. The negative electrode mixture density (packing density of the negative electrode active material layer) was set at 1.15 g/cm³, and the coating amount of the negative electrode mixture paste on each side was set at 90 g/m² in terms of the solid content of the negative electrode mixture paste.

[Battery Production] Production of 18650-Type Lithium Ion Secondary Battery

A PET nonwoven fabric was sandwiched between the above-prepared positive electrode plate and negative electrode plate, and the resultant was wound to prepare a wound-type electrode assembly. In this process, the wound-type electrode assembly was designed such that the resulting battery would have a capacity of 900 mAh. This wound-type electrode assembly was inserted into a battery container, and a negative electrode tab terminal, which had been welded to the negative electrode current collector in advance, was welded to the container bottom. Then, a positive electrode tab terminal, which had been welded to the positive electrode current collector in advance, was welded to a positive electrode external terminal in an electrically connected manner, after which a positive electrode cap was arranged on top of the container, and an insulating gasket was inserted therebetween. Subsequently, 6 ml of an electrolyte solution (manufactured by Ube Industries, Ltd.), which was obtained by adding vinylene carbonate in an amount of 0.8% by mass with respect to the whole amount of a mixed solution containing 1.2 M of LiPF₆ (ethylene carbonate:ethylmethyl carbonate:dimethyl carbonate=2:2:3 (volume ratio)), was injected into the battery container. Thereafter, the upper part of the battery container was caulked to tightly seal the battery, whereby an 18650-type lithium ion secondary battery was produced.

### Experimental Example 5B

An 18650-type lithium ion secondary battery was produced in the same manner as in Experimental Example 1B, except that a 30 μm-thick polyethylene separator having a Gurley value of 600 sec/100 cc (hereinafter, may also be referred to as “PE separator”) was used as the separator.

### Experimental Example 6B

An 18650-type lithium ion secondary battery was produced in the same manner as in Experimental Example 4B, except that a 30 μm-thick polyethylene separator having a Gurley value of 600 sec/100 cc was used as the separator.

(Heat Resistance of Separators)

The separators used in Experimental Examples 1B to 6B were each cut out into a size of 50 mm (MD)×50 mm (TD), placed on a glass substrate, and then heated for 1 hour in a thermostat chamber adjusted at 160° C. The size of each test piece after the heating was measured, and the thermal shrinkage rate (area shrinkage rate) was calculated using the following formula:

Thermal shrinkage rate (area shrinkage rate) (%)=(Area before heating−Area after heating)/Area before heating×100

[Battery Property (Discharge Capacity)]

For the 18650-type batteries obtained in Experimental Examples 1B to 6B, the discharge capacity at 25° C. was measured as a discharge capacity using a charge-discharge apparatus (trade name: TOSCAT-3200, manufactured by Toyo System Co., Ltd.) under the following charge-discharge conditions. After charging each battery to 4.2 V at a current of 450 mA, the battery was further charged to a current of 9 mA at 4.2 V (constant-current constant-voltage (CCCV) charging). Then, the battery was discharged to 2.7 V at 450 mA (CC discharging). The discharge capacity was measured and evaluated based on the following evaluation criteria. It is noted here that an evaluation of “A” was judged as the highest discharge capacity, while an evaluation of “C” was judged as the lowest discharge capacity.

A: 890 mAh or higher

B: 880 mAh or higher but lower than 890 mAh

C: lower than 880 mAh

[Battery Property (Discharge Rate Property)]

For the 18650-type batteries obtained in Experimental Examples 1B to 6B, the discharge capacity at 25° C. was measured as a discharge rate property using a charge-discharge apparatus (trade name: TOSCAT-3200, manufactured by Toyo System Co., Ltd.) under the following charge-discharge conditions. After charging each battery to 4.2 V at a current of 450 mA, the battery was further charged to a current of 9 mA at 4.2 V (constant-current constant-voltage (CCCV) charging). Then, the battery was discharged to 2.7 V at 4.5 A (CC discharging). The discharge capacity was measured, and a value obtained using the following Formula was evaluated as a discharge rate property based on the following evaluation criteria.

Discharge rate property (%)=(Discharge capacity at 450 mA)×100/(Discharge capacity at 4.5 A)

A: 90% or higher

B: 80% or higher but lower than 90%

C: lower than 80%

[Safety (Overcharge Property)]

A thermocouple and a ribbon heater were wound on the surface of each of the 18650-type batteries obtained in Experimental Examples 1B to 6B, and a heat insulating material was further wound thereon. After adjusting the surface temperature of each 18650-type battery to be 25° C., the battery was subjected to an overcharging test at a charging rate of 3 CA (2.7 A). The overcharging test was continued until the voltage reached 18 V, and the behavior of each 18650-type battery was observed to evaluate the safety based on the following criteria. It is noted here that an evaluation of “A” was judged as the highest safety, while an evaluation of “C” was judged as the lowest safety.

A: The 18650-type lithium ion secondary battery was neither ruptured nor ignited.

B: The 18650-type lithium ion secondary battery was ruptured or ignited.

C: The 18650-type lithium ion secondary battery was ruptured and ignited.

TABLE 2

| | | Experimental | Experimental | Experimental | Experimental | Experimental | Experimental |
|---|---|---|---|---|---|---|---|
| Item | | Example 1B | Example 2B | Example 3B | Example 4B | Example 5B | Example 6B |
| Positive | Ratio of | 88.0 | 88.0 | 88.0 | 88.0 | 88.0 | 88.0 |
| electrode | positive | | | | | | |
| active | electrode | | | | | | |
| material | active material | | | | | | |
| layer | (% by mass) | | | | | | |
| | Ratio of | 4.5 | 4.5 | 4.5 | 4.5 | 4.5 | 4.5 |
| | conductive | | | | | | |
| | particles | | | | | | |
| | (% by mass) | | | | | | |
| | Ratio of | 6.5 | 6.5 | 6.5 | — | 6.5 | — |
| | polyolefin | | | | | | |
| | particles | | | | | | |
| | (% by mass) | | | | | | |
| | Ratio of binder | 1.0 | 1.0 | 1.0 | 7.5 | 1.0 | 7.5 |
| | (% by mass) | | | | | | |
| | Melting point | 110 | 132 | 148 | — | 110 | — |
| | of polyolefin | | | | | | |
| | particles | | | | | | |
| | (° C.) | | | | | | |
| | Average | 9.5 | 6.0 | 1.0 | — | 9.5 | — |
| | particle size | | | | | | |
| | of polyolefin | | | | | | |
| | particles (μm) | | | | | | |
| Separator | Material | PET | PET | PET | PET | PE | PE |
| | (porous substrate) | nonwoven | nonwoven | nonwoven | nonwoven | separator | separator |
| | | fabric | fabric | fabric | fabric | | |
| | Thickness (μm) | 28 | 28 | 28 | 28 | 30 | 30 |
| | Gurley value | 20 | 20 | 20 | 20 | 600 | 600 |
| | (sec/100 cc) | | | | | | |
| | Thermal | 2 | 2 | 2 | 2 | 98 | 98 |
| | shrinkage | | | | | | |
| | rate (%) | | | | | | |
| Battery | Discharge | A | A | A | A | A | A |
| properties | capacity | | | | | | |
| | Discharge rate | A | A | A | A | B | B |
| | property | | | | | | |

| | | | | | | |
|---|---|---|---|---|---|---|
| Safety | A | A | A | C | C | C |
| (overcharge property) | | | | | | |

The batteries of Experimental Examples 1B to 6B all had equivalent discharge capacity.

The batteries of Experimental Examples 1B to 4B in which a PET nonwoven fabric was used as the separator exhibited superior discharge rate property as compared to the batteries of Experimental Examples 5B and 6B in which a PE separator was used as the separator. This result is attributed to the difference in the Gurley values of the separators.

The batteries of Experimental Examples 1B to 3B, which contained polyolefin particles in the positive electrode active material layer and used a PET nonwoven fabric as the separator, had superior battery safety as compared to those batteries of Experimental Examples 4B and 6B that contained no polyolefin particle in the positive electrode active material layer and the battery of Experimental Example 5B that contained polyolefin particles in the positive electrode active material layer but used a PE separator. This result is attributed to an effect that the resistance of the positive electrode active material layer is increased against heat generation of the respective lithium ion secondary batteries and an effect that the shape of the separator is maintained even when the batteries generate heat.

From these results, it was suggested that a lithium ion secondary battery including a positive electrode, a negative electrode, a separator and an electrolyte, wherein the positive electrode includes a current collector and a positive electrode active material layer formed on the current collector, the positive electrode active material layer contains a positive electrode active material, polyolefin particles, conductive particles and a binder, and the separator has a thermal shrinkage rate of 30% or less at 160° C., is useful as a battery having excellent battery properties and safety. Further, according to the disclosure, the production process is also simple since a PTC function can be imparted to a lithium ion secondary battery without separately arranging a PTC layer.

The lithium ion secondary battery of the invention is highly safe. Particularly, the lithium ion secondary battery of the invention can be suitably used as a power source of various portable electronic devices, such as cellular phones, laptop computers, portable information terminals, electronic dictionaries, and gaming consoles. When the lithium ion secondary battery of the invention is utilized in such applications, since heat generation is suppressed even if the battery is overcharged during charging, an increase in the battery temperature, swelling of the battery and the like are inhibited. In addition, rupture, ignition and the like of the lithium ion secondary battery are suppressed. Furthermore, the lithium ion secondary battery of the invention can also be utilized in other applications, such as power storage and transportation machines (e.g., electric cars and hybrid cars).

The disclosures of Japanese Patent Application Nos. 2016-008470 and 2016-008471, which were filed on January 20, 2016, are hereby incorporated by reference in its entirety.

All the documents, patent applications and technical standards that are described in the present specification are hereby incorporated by reference to the same extent as if each individual document, patent application or technical standard is concretely and individually described to be incorporated by reference.

1. A lithium ion secondary battery, comprising:
a positive electrode;
a negative electrode;
a separator; and
an electrolyte, wherein:
the positive electrode comprises a current collector and a positive electrode active material layer formed on the current collector,
the positive electrode active material layer comprises a positive electrode active material, polyolefin particles, conductive particles and a binder, and
the separator has a thermal shrinkage rate of 30% or less at 160° C.

2. The lithium ion secondary battery according to claim 1, wherein:
the separator comprises a porous substrate and inorganic particles, and
the porous substrate comprises two or more different kinds of resin selected from the group consisting of a polypropylene resin, a polyethylene resin, a polyvinyl alcohol resin, a polyethylene terephthalate resin, a polyacrylonitrile resin, and an aramid resin.

3. The lithium ion secondary battery according to claim 2, wherein the porous substrate comprises a polyethylene resin and a polypropylene resin.

4. The lithium ion secondary battery according to claim 1, wherein the separator has a thermal shrinkage rate of 20% or less at 160° C.

5. The lithium ion secondary battery according to claim 1, wherein the separator has a Gurley value of 1,000 sec/100 cc or less.

6. The lithium ion secondary battery according to claim 1, wherein:
the separator comprises a porous substrate and inorganic particles, and
the porous substrate comprises a polyester resin.

7. The lithium ion secondary battery according to claim 6, wherein the polyester resin comprises a polyethylene terephthalate resin.

8. A lithium ion secondary battery, comprising:
a positive electrode;
a negative electrode;
a separator; and
an electrolyte, wherein:
the positive electrode comprises a current collector and a positive electrode active material layer formed on the current collector,
the positive electrode active material layer comprises a positive electrode active material, polyolefin particles, conductive particles, and a binder,
the separator comprises a porous substrate and inorganic particles, and
the porous substrate is a layered body comprising a polypropylene resin and a polyethylene resin disposed alternately in layers.

9. A lithium ion secondary battery, comprising:
a positive electrode;
a negative electrode;
a separator; and
an electrolyte, wherein:
the positive electrode comprises a current collector and a positive electrode active material layer formed on the current collector,
the positive electrode active material layer comprises a positive electrode active material, polyolefin particles, conductive particles and a binder, and
the separator comprises a woven or nonwoven fabric of a polyethylene terephthalate resin, and inorganic particles.

10. The lithium ion secondary battery according to claim 2, wherein the inorganic particles comprise at least one of aluminum oxide (Al2O3) or silicon oxide (SiO2).

11. The lithium ion secondary battery according to claim 1, wherein the separator has a thickness of from 5 μm to 100 μm.

12. The lithium ion secondary battery according to claim 1, wherein the binder comprises a resin including a structural unit derived from a nitrile group-containing monomer.

13. The lithium ion secondary battery according to claim 6, wherein the inorganic particles comprise at least one of aluminum oxide (Al₂O₃) or silicon oxide (SiO₂).

14. The lithium ion secondary battery according to claim 8, wherein the inorganic particles comprise at least one of aluminum oxide (Al₂O₃) or silicon oxide (SiO2).

15. The lithium ion secondary battery according to claim 9, wherein the inorganic particles comprise at least one of aluminum oxide (Al₂O₃) or silicon oxide (SiO₂).

16. The lithium ion secondary battery according to claim 8, wherein the separator has a thickness of from 5 μm to 100 μm.

17. The lithium ion secondary battery according to claim 9, wherein the separator has a thickness of from 5 μm to 100 μm.

18. The lithium ion secondary battery according to claim 8, wherein the binder comprises a resin including a structural unit derived from a nitrile group-containing monomer.

19. The lithium ion secondary battery according to claim 9, wherein the binder comprises a resin including a structural unit derived from a nitrile group-containing monomer.
